(19) United States
(12) Patent Application Publication
(10) Pub. No.: US 2003/0158742 A1
(43) Pub. Date: Aug. 21, 2003

(54) System and method for providing marketing resources to the insurance and financial professional through a global computer network

(76) Inventors: Mike Ford, Phoenix, AZ (US); Jonathan Illig, Phoenix, AZ (US)

Correspondence Address: MYERS & KAPLAN, INTELLECTUAL, PROPERTY LAW, L.L.C., 1827 POWERS FERRY ROAD, BUILDING 3, SUITE 200,, ATLANTA, GA, 30339, US

(21) Appl. No.: 10/078,632

(22) Filed: Feb. 19, 2002

(51) Int. Cl. G06F 17/60

(52) U.S. Cl. 705/1; 705/10; 705/4; 705/35

(57) ABSTRACT

A method for managing customer relationships, which utilizes a global information network, which is administered by a proprietor for a plurality of producers. The method comprises the producer providing a customer database that is in communication with the proprietor's global information network while the proprietor organizes the information to be sent to selected customers by the producer. The proprietor uses software to send the information to selected customers of the producer. The proprietor can have a central database that includes customer records of all of the producers, with each producer having secured access to the producer records in the central database. The central database can be automatically scanned, at predetermined times, to determine due events for each customer record. An apparatus for practicing this method is also disclosed.

### FIELD OF THE INVENTION

This invention relates a system and method for improving the performance of customer management relationship activities and providing a marketing resource to the insurance and financial professional for the small or home office which uses a global computer network to manage customer relationships.

### BACKGROUND OF THE INVENTION

A typical small office or home office of an insurance or financial professional does not have the time, technical or creative skills to conduct effective customer relationship management and marketing. An insurance or financial professional in a small office is typically well skilled in his or her core of business. However, the majority of such persons are not skilled in the support skills of writing, graphic design, technical operation of computers or software, which are needed to effectively market their services on an ongoing basis. To do the best job, as best seen on FIG. 1, often the small office or home office will out-source such services to an advertising or marketing firm, or hire an in-house employee with the requisite skills. However, often such options are prohibitively expensive.

Another option is for the small office or home office of the insurance and financial professional to organize seminars to generate leads for potential clients, often at great expense. While in this approach some sales can be closed immediately, but typically, the majority of leads are not ready to purchase at the time of the initial approach. In order to close the sale, it is necessary to keep the small offices or home office name in front of the lead. At present, small offices or home offices employ a number of techniques to do so, including the simple telephone call.

In one technique, such office of the insurance and financial professionals may mail newsletters purchased from outside sources, such as trade associations in the insurance and financial fields. Such newsletter may offer some customization; however, in most instances, such modifications are very minimal. The newsletters are sent to the leads sometimes via an electronic mailing list supplied to the vendor but most often via mailing labels printed and affixed at the office via computer.

Sometimes, the office may create and publish its own newsletter. However, the time requirements for a small office or home office principal to produce a letter often creates great difficulties resulting in sporadic cycles of communication completion.

One downside of commercial letters is the perception that such mailings are not perceived as direct communication from office to the client/customer. Rather, such mass mailings are perceived as bulk mail third party products.

Another option is to utilize commercial software applications, such as Goldmine^{SM} or ACT^{SM} on a computer, which organizes leads and generates reminders for follow-up actions such as sending birthday cards, reminder letters, and other letters and document the interaction with the client. The programs can generate a list for vendors to mail newsletters, but to do so requires the small office or home office to execute file downloads. Otherwise, the office has to print labels, letters, envelopes, stamps, in order to do the customer mailings. The above software packages are complex and difficult to use and often beyond the skill level of the small office or home office personnel, even through they are professionals.

Other commercial word processing software, such as Mail Merge^{SM} allows a user to merge a custom list into letter for bulk mailing. Like file downloads, such merges tend to be complicated processes, which most small or home offices find impossible or difficult to use.

All of the above solutions are expensive in labor, postage, and require the maintenance of several customer lists. For example, one computer may have a customer list in Goldmine^{SM} and another in Word^{SM} and another in the accounting system. None of the present software packages operate from a single, central list.

### PRIOR ART

U.S. Pat. No. 5,983,200 entitled “Intelligent Agent for Executing Delegated Tasks” which issued on Nov. 9, 1999 to Slotznick disclosed an intelligent agent software program including databases and learning modules for executing tasks, receiving commands, tracking customer contracts, sending notices, placing orders, managing deliveries and the like. This invention covers a system, which serves as an intelligent agent, which expedites electronically placed orders, purchases, etc. for variety of goods and services. This invention allows the delegated tasks to be carried out in the present, and some time in the future or in a repetitive fashion. This invention can be used to choose or create professional greeting cards at a Kiosk or on-line. This invention teaches a system for reproducing information itself at a point of sale or at a different time or place.

U.S. Pat. No. 6,031,895 entitled “Network-Based Multimedia Communications and Directory Systems and Method of Operation” which issued on Feb. 29, 2000 to Cohn et al. shows a system for communication with customers including a customer service system (161), a message tracking system (163), a billing system (159), and a system for synchronizing a plurality of databases (claim 1). The communication system of this invention connects a number of network hubs. In this invention, a network-based voice and multimedia communication system uses a number of network hubs to communicate with each other and with local messaging systems. The network hubs can maintain and store user profiles that include user preferences. In this invention, a network hub can receive a message through a messaging system and transmit the message through the communication network.

U.S. Pat. No. 5,309,355 entitled “Automated Sales System” which issued on May 3, 1994 to Lockwood provides a support system for sales and marketing including means for profiling potential clients, a means for identifying clients, a means for tailoring sales presentations to clients based upon profiles and smart cards (claim 1). The hierarchy of data sources can be arranged so that a large number sale presentations and configurations can be created and used. This invention is designed to be used in conjunction with computerized airline reservation systems. The sales terminals of this invention are linked to a computerized airline reservation system.

U.S. Pat. No. 6,014,644 entitled “Centrally Coordinated Communication Systems With Multiple Broadcast Data Objects and Response Tracking” which issued on Jan. 11, 2000 to Erickson discloses a system for facilitating communication between buyers and sellers including a message and response tracking linked to a central database performing company profiling and information distribution (claim 1). Under this system and method, buyers may browse the database and assemble a list of suppliers who will receive a request for a bid. The message and response tracking object serves as a central repository for all communication between buyers and suppliers concerning the bid.

In addition, the present software tools such as Word^{SM}, Goldmine^{SM} and ACT^{SM} provide a huge number of features, many of which a small office or home office simply does not need. However, such a plethora of features makes the software complex and difficult to employ.

To summarize, the small office or home office loses a lot of leads due to primitive customer relationship management and, unfortunately, the present remedies are expensive and difficult to use and manage. Thus, there is an overpowering need for a method and apparatus for the small office or home office, which is inexpensive and easy to use to manage customer relationships.

### SUMMARY OF THE INVENTION

One object of the invention is to provide a method and system to allow small and home office for insurance or financial professionals to perform customer management relationships and marketing activities with superior quality and effectiveness at a reduced cost.

Another object of the invention is to a provide method and system for customer management activities, which is easy to use and employs a single database for accounting, letter composition, financial calculators, marketing information, and delivers it where needed using global information network.

Further objects and advantages of the invention will become apparent as the following description proceeds and the features of novelty which characterize this invention will be pointed out with particularity in the claims annexed to and forming a part of this specification.

The objects of this invention are met by providing a system and method through a customer relationship management network. This network is handled by a proprietor's mechanism and with the heart of the network consisting of the mailing software utilizing the producer's (i.e. insurance or financial professional) customer list. The mailing software of this invention can automatically mail or email information in a personalized way to the client or prospective client whether it is a newsletter, birthday card, anniversary card, or an event invitation. This method and system saves a great deal of time for the producer in the system in that, a newsletter can be produced by the proprietor which is approved by the producer prior to being sent. This system is also designed to provide a website for the producer which can be customized to the producer's individual needs.

The integrated newsletter and website permits regular communication between the producer and his clients and prospects, turning prospects into clients. The clients or prospects can respond to an email or newsletter by logging onto the producer's Website or calling the producer directly. The integrated system and method of this invention allows the producer to have extensive and periodic contact with clients and prospective clients. This system and method is designed to be used on a computer network preferably on a global computer network.

### BRIEF DESCRIPTION OF THE DRAWING

The present invention may be more readily described by reference to the accompanying drawings in which:

FIG. 1 is a schematic diagram showing the methods employed in the prior art;

FIG. 2 is a schematic diagram showing the customer relationship management system and method of the present invention;

FIG. 3 is a schematic diagram illustrates contact detail of clients and prospective clients.

FIG. 4 is a schematic diagram of the computer monitor screen by which a producer may select an article for distribution.

### DESCRIPTION OF THE PREFERRED EMBODIMENT

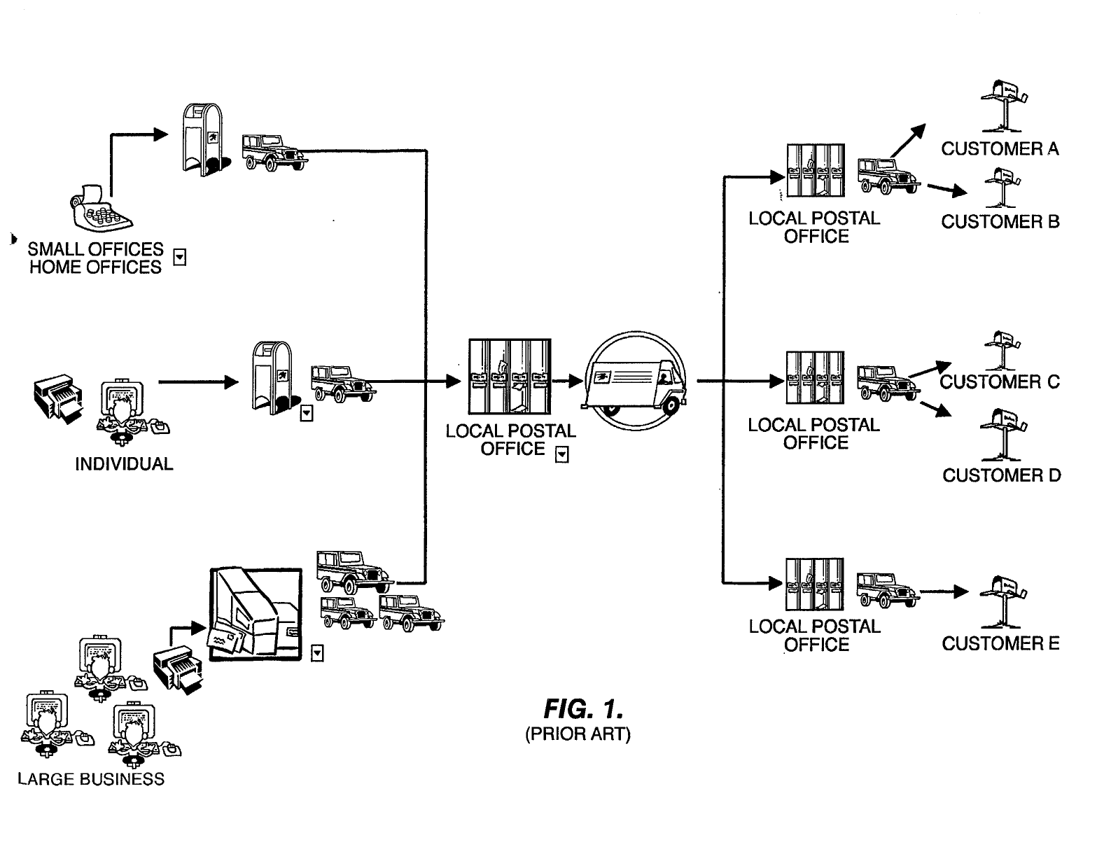

FIG. 1 represents the methods employed by the prior art where both small and large offices use the local Post Office to deliver messages that they have prepared for customers in different areas.

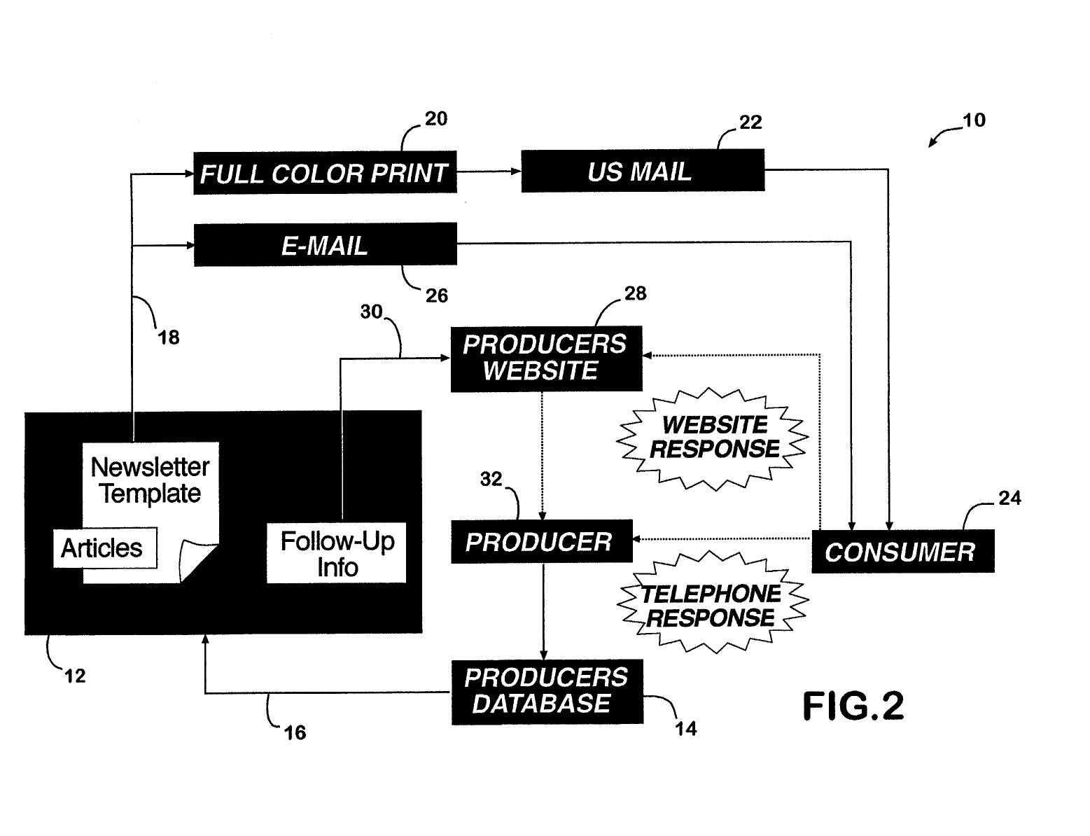

Referring more particularly to the drawings by characters of reference, FIGS. 2-4 discloses the operation and elements of the system and method in accordance with the present invention.

The method of the present invention is illustrated FIG. 2 where the numeral 10 refers to a customer relationship management network. The heart of the network consists of the mailing applications server with a software mechanism 12 and the producer's customer relationship management database 14, which is integrated with the mailing software mechanism 12 as indicated by arrow 16. It should be understood that the term “producer” refers to the insurance or financial professional. However, any small or home office can utilize the system and method of this invention.

The mailing software mechanism as illustrated by arrow 18 12 can be programmed to either mail the letter or newsletter by U.S. mail or email or a combination thereof depending upon the particular client involved. This mechanism 12 has the capability of producing a full color print 20 of a newsletter or a regular letter and sending it by U.S. mail 22 to the consumer or client 24. Similarly, this newsletter or regular letter can be sent by email 26 to the consumer 24. As part of this customer relationship management network 10 a producer's website 28 may be created. Follow-up information may be placed on the producer's website 28 as indicated by arrow 30. The producer's database 14 holds contact and personal information about clients and prospetive clients. The producer's database can be included in the proprietor's central database. It can also include appointment schedules. It is provided by the insurance and financial professionals 32. The producer 32 can readily view client/prospective information through his/her computer.

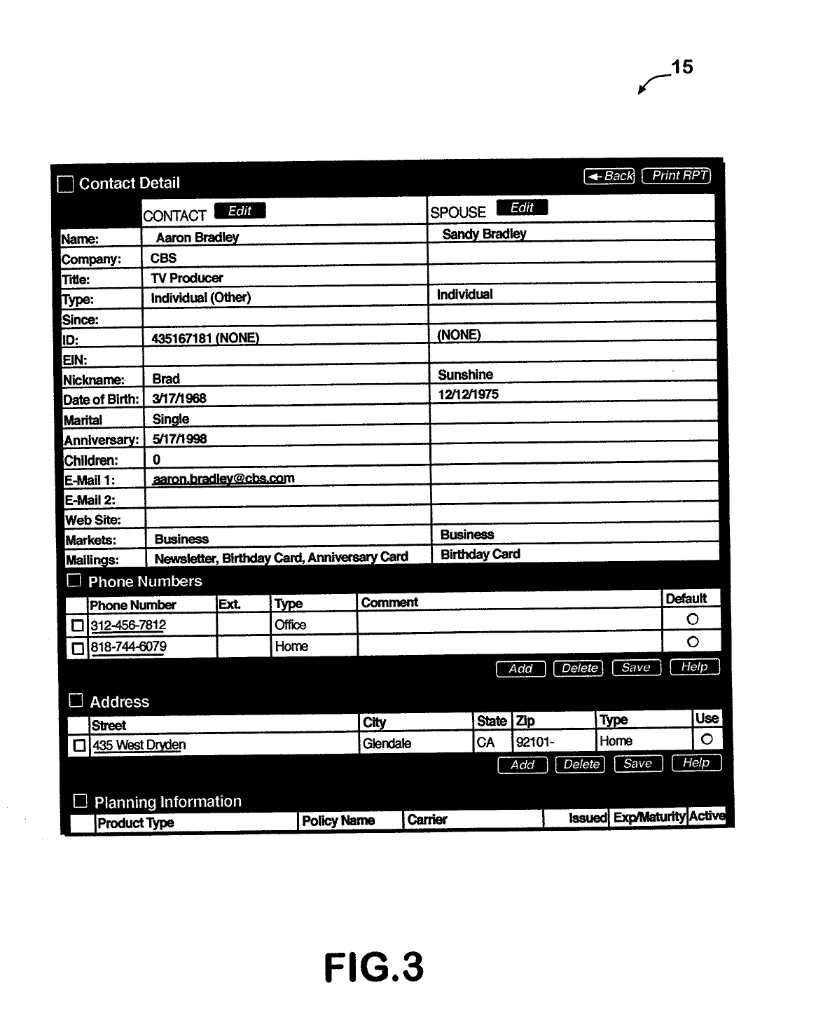

Contact information can be stored concerning each individual client or prospective client as illustrated by FIG. 3.

This contact information about a client or prospective client in the database 15 (FIG. 3) can include important marketing information and details such as home and office phone numbers, addresses, name of spouse, name of employer, birthday, wedding anniversary, etc. The database of the client or prospective client can contain a lot of contact information as illustrated by FIG. 3. It can contain tables, letterhead, newsletters, logos and form letters. Each individual record of particular office of a producer is indexed to that office, which in turn, is provided with browser based customer relation management module, which includes an administration program including passwords to permit that producer to access its own records but not that of another producer. New records can be added and existing records can be edited. The contact data can include any date related data such as when a certificate of deposit is maturing, reminder dates, retirement dates, and birthdays. This contact information can provide scheduled telephone call back, documents, or even records of customer conversations, reminders of birthday, anniversaries or other events, and schedule meeting and seminars. There is only one record per client, and, if duplicate records come from different office, a duplication check is utilized to catch and prevent duplication. If a duplicate exits, the new record is deleted and a link to the existing record provided. The address is then standardized and the record placed into the database. To prevent one producer from accessing the records of another producer, strict quality controls are maintained via use of Mil45208 or Mil9558 standards with periodic audits to ensure compliance with same.

From this database, the mailing software mechanism 12 can automatically mail or email the contact the type of mailing the client should receive, whether it is a newsletter, birthday card, or anniversary card. If the client specifically does not want to receive a birthday card or anniversary card, the preference can be noted so it is not sent automatically.

The mailing software mechanism 12 is established so that it can print and mail for one client or be emailed for another client.

The periodic newsletters that are sent by this system may be prepared by the proprietor of this system, the producer or another source. The newsletter is produced by the proprietor and displayed to the producer for his/her approval prior to being sent. A major improvement of the present invention over the prior art is the ability to process newsletters, which will have an individual producer's logo, picture and identity information and will be specifically addressed to individual clients. Thus, the mass mailings will appear to the client to be personally generated by a particular producer while having the economies of scale inherent to printing and mailing.

The use of this mailing software mechanism creates an enormous cost advantage whereby one page, two sided, full color custom newsletters can be dispatched for approximately $1.50 each including first-class postage. A comparable 500-piece newsletter produced in house, even using a software package such as Goldmine^{SM}, cost about $3 per piece for black ink on one side of the paper. Thus, a major benefit of the present invention, in addition to cost savings, is the high quality of the individualized mailings.

In the present invention, the producer locates the newsletter article in the database and selects the customer or group of customers to receive same and the newsletter preparation is released. Or, if desired, a schedule of mailings of different form letters for several months can be organized. As new leads/clients/customers are acquired, the producer merely assigns appropriate mailings for each.

Automatically, at predetermined times, the mailing software (12) scans the central database and determines the due events for each client of each producer. The mailing software (12) generates large files for bulk printing, sorting for optimum first-class mailing costs and optimized for the printing vendor. Each document is merged with the appropriate logos, photos, and addresses of particular producers and addressed in a personal font to the particular client. All communication history is saved for each client and thus the producer need not worry about envelopes, postage, walking out to the mailbox or filing a copy in a drawer.

This system is designed to provide a website 28 for the producer. This website can be customized for an individual producer of the system. This website can be designed to provide additional follow-up information regarding the article contained in the newsletter and other information about products or services that are provided by the producer.

The system and method of this invention maintains client information, marketing and communication history, and seamlessly integrates the newsletter and greeting card features. The newsletters and greeting cards can be customized with the image of the producer and addressed to each client, which basically provides a one-to-one marketing effort.

The system and method of this invention provides a producer with an additional opportunity to build his/her image with clients and prospects through the integrated newsletter and website. This total system allows the producer to generate additional sales from existing clients and turn prospects into clients through regular communication. Once the client 24 has received an email or letter via U.S. mail, the client can respond by logging on the producer's website 28 or by calling the producer directly.

This system keeps the producer in contact with the client and prospective client through periodic messages and newsletters. Therefore, when the client or prospective client is ready to purchase he/she will think of the producer because of the recent contact.

This system of this invention eliminates the hassle of consistently backing up database information dealing with useless data fields, frustrating operating errors, printing, labeling, merging and mailing client correspondence. The proprietor of this system does the printing, labeling and mailing.

The proprietor of this system provides templates for website newsletters, birthday and anniversary cards, and article and photo laboratories from which the producer can choose.

Most producers in the insurance and financial field spend considerable time and money developing leads through developing seminars, direct mail and print advertising. Research has shown that the majority of the developed leads do not ultimately lead to sales. For example, a typical seminar may attract 20 potential clients. Of those 20 potential clients, 10 may express an interest in obtaining either additional information or a meeting with the producer. Of those 10, perhaps 3 to 5 will ultimately purchase an insurance or financial product from the producer. Unfortunately, the consumers that attend the seminar may not decide to purchase any services or products for several weeks or even months. By that time, they may have forgotten about the producer. In order to ultimately generate sales from a higher percentage of developed leads, the producer must proactively remain in contact with those leads. A newsletter is a proven means of remaining in contact. The image of the producer is reinforced in the minds of the client by a consistently delivered newsletter bearing the photo and business image of the producer. The newsletter can also introduce new planning and product concepts that may be of interest to both prospective clients and the existing clientele. The system of this invention makes re-marketing simple and effective.

The proprietor of this system and method may provide a Website including hosting by easy to follow, step-by-step instructions for creating a site. The producer will control the content of the Website and can easily update and change the site anytime that is desired. In addition, for registered securities and investments advisory representatives, the system facilitates the regulatory requirement of compliance approval.

The print-for-one technology allows the producer to have a communication printed effortlessly. The producer does not need to deal with envelopes, stamps, merging, printing and ultimately delivery to the Post Office. A big advantage of the system of this invention is that it allows the producer to create a full color print of the communication pieces. Each piece of mail is personalized with the producer's message and is addressed to the client or prospect by name and all this is accomplished in the convenience of the producer's home or office.

This system can be made secure for the producer by requiring a login name and password. These are necessary for the producer to enter his/her private Website and database.

Because of the efficiency of this system, and in particular the mailing software mechanism 12, the cost of providing the newsletter and card is very competitive. It is designed to be used by a producer with a very small client base.

The system of this invention has been customized especially for fields of insurance and financial services, although it can be utilized for other fields as well.

One of the features of this system and method is that it permits the producer to track the first marketing contact of a client or prospect, which may be used to tailor marketing communications to specific client or prospect.

The proprietor of this system and method may write the content, create the document layout, print, fold, and postmark newsletters. This step saves a lot of time for the producer. The proprietor can also provide the article and allow the producer to select the newsletter template that is printed, folded and mailed by the proprietor.

The newsletter is printed on both sides and in full color if specially written to tell the reader (client or prospect) to call the producer directly or go to the producer's Website to learn more about the issue that is raised in the newsletter. The newsletter can be personalized by full color graphics and producer's photo along with a personal message with upcoming seminar dates.

In today's world there is keen interest in the security of computer files. The software of the mailing software mechanism 12 encrypts all files before they are sent from the producer's computer to the proprietor's production facility.

The security of this system is maintained by the security technology called Secure Socket Layer, a protocol developed by Netscape, for the secure transmission of private information over the Internet. This system operates by using a private key to encrypt messages transmitted over the network connection. A firewall protects the proprietor's computer system by refusing entry to what is not authorized. The proprietor's computer system does not download or record the database information on the producer's hard drive unless specifically requested by the producer. All the producer's data remains protected behind the firewall so that unauthorized people cannot access the data without the producer's login name and password.

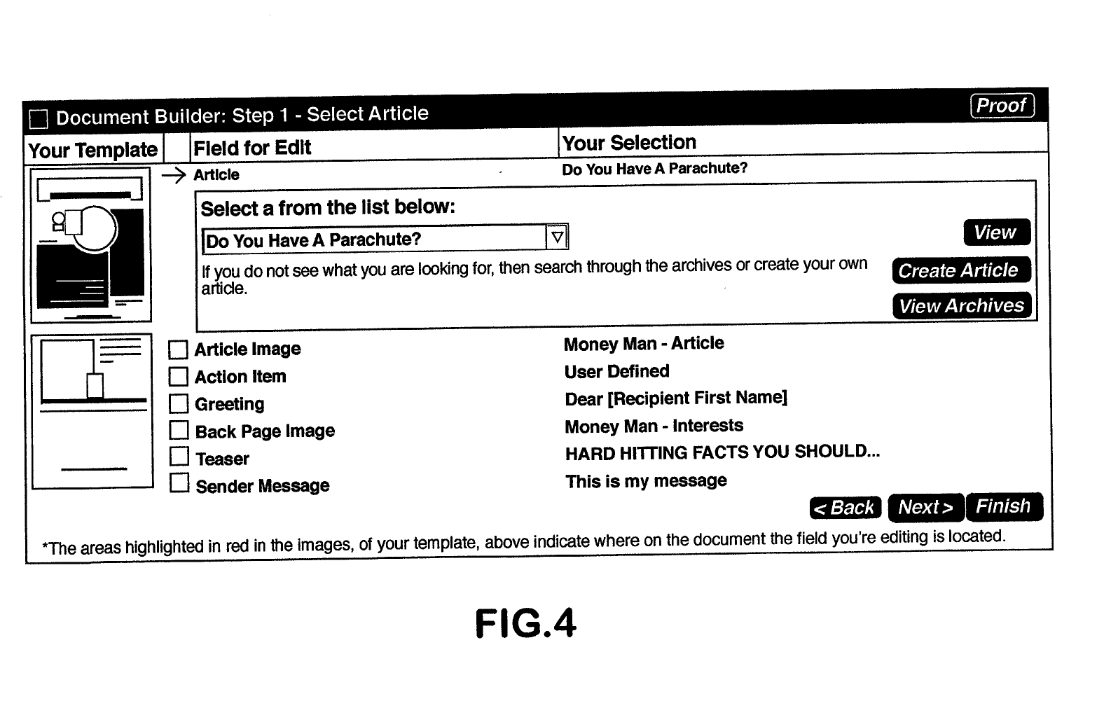

FIG. 4 illustrates the ways in which a producer can build the custom “print-for-one” newsletter. This system allows the Producer to either select an article from the library or write his/her article.

An article image can be selected for the article that the producer selects, if desired. An archive can be maintained so that the producer can search through the archives to find an article of interest.

The newsletter can be personalized by permitting the producer to select the type of greeting desired on the front of the newsletter, such as “Dear John” or “Dear Mr. Smith”. An image can be printed on the back page of the article, if desired. In addition, a teaser that is designed to get the client or prospective client to come back or to call the producer can be included in the article.

It will be apparent to those skilled in the art that various changes and modifications may be made therein without departing from the spirit of the invention or from the scope of the appended claims.

What is claimed is:

1. A method for managing customer relationships which utilizes a global information network, administered by a proprietor for a plurality of producers, the method comprising:
a. the proprietor providing a global information network;
b. each producer providing a customer database in communication with the proprietor's global information network;
c. the proprietor organizing the information to be sent to selected customers of each producer; and
d. the proprietor sending the organized information to each producer for approval; and
e. the proprietor utilizing software to send the information to selected customers of a producer.

2. The method of claim 1 in which the producer is an insurance professional.

3. The method of claim 1 in which the producer is a financial professional.

4. The method of claim 1 in which the global information network includes an email link to the customers to whom the organized information is sent by email.

5. The method of claim 1 in which the proprietor's software includes the capability of sending the information by email or U.S. mail according to the preference of the customer to whom the organized information is sent by email or U.S. mail at the customer's preference.

6. The method of claim 1 in which the producer database is stored in a central database of the proprietor.

7. The method of claim 6 in which the central database also stores specific records of the producer including tables, letterhead, newsletters, logos and form letters.

8. The method of claim 6 in which each producer has the capability of accessing records of his customers in the central database to edit, add or delete the customer records of this producer.

9. The method of claim 1 in which the proprietor's software has the capability to personalize the organized information by including a personal greeting to the customer and the producer's address and name to indicate that the information originates with the producer and the method performs this operation.

10. The method of claim 1 further comprising the step of providing quality assurance protocols which comply with Mil45208 standards with periodic audits to assure compliance with the same.

11. The method of claim 1 further comprising the step of providing quality assurance protocols which comply with Mil9558 standards with periodic audits to assurance compliance with the same.

12. The method of claim 1 in which the proprietor provides a website for the producer which can be accessed by a customer of the producer who received the organized information.

13. The method of claim 1 in which the information being sent is a message about an event happening to the customer with the event information being included in the customer database with the event being processed by the proprietor's software for sending to the customer having the event at the appropriate time in advance of the happening of the event.

14. The method of claim 13 in which the information being sent is further personalized with a photograph of the producer.

15. The method of claim 6 in which the producer's customer database is protected from access by others by requiring a login name and password known only to the producer.

16. The method of claim 1 in which the proprietor utilizes a global information network and provides an application server in communication with the global information network and creates a central database in communication with the applications server in which customer records from a plurality of producers are stored in the central database.

17. The method in claim 6 in which the central database is automatically scanned, at predetermined times, to determine due events from each customer's records of a producer and sending a appropriate message to such customer about an event happening at the appropriate time in the advance of the event happening.

18. The method of claim 6 further comprising the step of checking each added customer record by a particular one of the producers for duplication with customer records with records in the central database, and, if an existing customer record is found, deleting the new customer record and indexing the existing customer record to the original producer.

19. The method of claim 17 further comprising the step of creating an individual letter at one of the plurality of producers, transferring the letter to the central database and generating and mailing the individual letter on the next automatic scanning.

20. A method for managing customer relationships which utilizes a global information network, the method comprising the steps of:
a. providing an applications server with a communication with a global information network;
b. creating a central database in communication with the applications server;
c. storing customer records from a plurality of producers in the central database, each customer record from one of the plurality of producers being indexed to the one of said plurality of producers;
d. providing a browser based customer relations management model having a secured administration program permitting a particular one of a plurality of producers to access, edit and add the customer record indexed to a particular one of the plurality producers;
e. the proprietor organizing the information to be sent to selected customers of the producer; and
f. the producer sending the organized information to the producer for approval; and
g. the proprietor using software to send the information to selected customers of a producer.

21. An apparatus for managing customer relationships, which utilizes a global information network, the apparatus comprising:
a. an application server in communication with a global information network, the applications server having a central database in communication therewith, the central database having customer records from a plurality of producers stored therein, each customer record from one of the plurality of producers being indexed to one of said plurality of producers;
b. a browser based customer relations management module having a secured administration program permitting a particular one of the plurality of producers to access, edit and add the customer records indexed to a particular one of the plurality of producers;
c. a mail bulking software mechanism for automatically scanning, at predetermined times, the central database to determine due events for each customer record, the mail bulking software mechanism associating with each due event the specific records from the particular one to the plurality of producers indexed to the customer record associated with the due event, the mail bulking software mechanism generating files for bulk printing based on the due event associated with one of the customer records indexed to one of the specific records; and
d. a targeted software module having software tools, each of the software tools being targeted at a particular category of the plurality of producers.

22. The apparatus of claim 21 wherein the browser based customer relations management module checks each added customer record by a particular one of the plurality of producers for duplication with the customer records in the central database, and, if an existing customer record is found, deletes the new customer record and indexes the existing customer record to the one of the plurality of producers.

23. The apparatus of claim 21 wherein the browser based customer relations management module standardizes an address format associated with each of the customer records.

24. The apparatus of claim 21 wherein the browser based customer relations management module allows the one of the plurality of producers to create an individual letter and transfer the letter to the central database, the mail bulking software mechanism thereafter generating and mailing the individual letter on the next automatic scanning.

25. The apparatus of claim 21 in which the global information network includes the capability of sending the information to a customer by email or U.S. mail according to the preference of the customer.

26. The apparatus of claim 21 in which software is included which has the capability to personalize the organized information that is being sent to a customer by including a personal greeting to the customer and the address and name of a third party to indicate that the information originates with the third party.
